(19) United States
(12) Patent Application Publication
(10) Pub. No.: US 2013/0183864 A1
(43) Pub. Date: Jul. 18, 2013

(54) READILY DISENGAGEABLE MULTI-PIN MALE PLUG CONNECTORS

(71) Applicant: Casey Hopkins, Portland, OR (US)

(72) Inventor: Casey Hopkins, Portland, OR (US)

(21) Appl. No.: 13/740,633

(22) Filed: Jan. 14, 2013

Related U.S. Application Data
(60) Provisional application No. 61/587,564, filed on Jan. 17, 2012.

(51) Int. Cl. H01R 13/46

(52) U.S. Cl. CPC H01R 13/46
USPC 439/660

(57) ABSTRACT

Male plug connectors including an insert configured to insert into a complimentarily configured receptacle, the insert defining a recess and including one or more insert electrical contacts mounted within the recess in a position to contact one or more corresponding receptacle electrical contacts, and a retraction mechanism operatively connected to the insert and configured to urge the insert out of the receptacle when a user desires to withdraw the insert from the receptacle. In some examples, the retraction mechanism includes a first wedge member adjacent the insert on a first lateral side of the insert, and a second wedge member adjacent the insert on a second lateral side of the insert, wherein the first wedge member and the second wedge member are each configured to move between a rest position distal the insert and a loaded position proximate the insert.

### CROSS REFERENCE TO RELATED APPLICATIONS

This application claims priority to copending U.S. Application, Ser. No. 61/587,564, filed on Jan. 17, 2012, which is hereby incorporated by reference for all purposes.

### BACKGROUND

The present disclosure relates generally to multi-pin male plug connectors. In particular, multi-pin male plug connectors with features to enable a user to readily disengage them from a device are described. Throughout this application, multi-pin male plug connectors, in particular 30-pin male plug connectors are described in detail for the sake of brevity and convenience. However, the reader should understand that the teachings described herein may be applied to a wide variety of plug connectors beyond merely 30-pin male plug connectors, such as 9-pin connectors.

Known plug connectors are not entirely satisfactory for the range of applications in which they are employed. For example, existing plug connectors often “stick” in the female receptacle of a device they are connected to, making it difficult and cumbersome for the user to disconnect the plug connector from the device. The undesirably tight fit between conventional plug connectors and device receptacles makes it inconvenient for the user to disengage the plug connector from the device.

A particularly inconvenient consequence of the undesirable disengagement characteristics of the conventional plug connectors is found in contexts involving docking stations, which are also referred to as base stations. Many users find it convenient to use a base station with a handheld device. A base station is designed to support a device while the device is connected to a plug connector. Base stations generally support a device in an upright position with a base and include a plug connector supported by the base in a position to engage a device supported by the base.

With conventional plug connectors incorporated into base stations, a user must generally use two hands to disengage the plug connectors from devices supported by the base stations: one hand to lift the device and the other hand to hold the base steady. Needing to use two hands is not convenient or desirable. Further, when a user attempts to remove a device from a base station incorporating conventional plug connectors, the user is prone to knock over or drop the device, potentially damaging the device.

Thus, there exists a need for plug connectors that improve upon and advance the design of known plug connectors. Examples of new and useful plug connectors relevant to the needs existing in the field are discussed below.

Disclosure addressing one or more of the identified existing needs is provided in the detailed description below. Examples of references relevant to multi-pin male plug connectors include U.S. Pat. Nos. 5,871,378, 6,485,315, 6,663,406, 6,709,286, 6,796,839, 6,945,824, 6,948,983, 7,160,120, 7,440,287, 7,918,689, 2001/0010983, 2003/0100203, 2003/0129879, 2004/0145875, 2007/0004282, 2007/0141915, 2008/0155824, 2009/0053932. The complete disclosures of the above patents and patent applications are herein incorporated by reference for all purposes.

### SUMMARY

The present disclosure is directed to male plug connectors including an insert configured to insert into a complimentarily configured receptacle, the insert defining a recess and including one or more insert electrical contacts mounted within the recess in a position to contact one or more corresponding receptacle electrical contacts mounted within the receptacle when the insert is inserted into the receptacle, and a retraction mechanism operatively connected to the insert and configured to urge the insert out of the receptacle when a user desires to withdraw the insert from the receptacle. In some examples, the insert includes a leading edge that leads the insert into the receptacle, a first lateral side, and a second lateral side opposite the first lateral side, and the retraction mechanism includes a first wedge member adjacent the insert on the first lateral side of the insert, and a second edge member adjacent the insert on the second lateral side of the insert, wherein the first wedge member and the second wedge member are each configured to move between a rest position distal the insert and a loaded position proximate the insert.

### BRIEF DESCRIPTION OF THE DRAWINGS

FIG. 1 is an isometric view of a male plug connector according to the present disclosure.

FIG. 2 is a front elevation view of the male plug connector of FIG. 1 with wedge members in a rest position.

FIG. 3 is a front sectional view of the male plug connector of FIG. 1 depicting the wedge members in a compressed or loaded position.

FIG. 4 is a side elevation view of the male plug connector of FIG. 1.

FIG. 5 is a rear elevation view of the male plug connector of FIG. 1.

FIG. 6 is a top plan view of the male plug connector of FIG. 1.

FIG. 7 is a bottom plan view of the male plug connector of FIG. 1.

FIG. 8 is an isometric view of a first example of a retraction mechanism that may be included in male plug connector described herein.

FIG. 9 is a front elevation view of the retraction mechanism of FIG. 8.

FIG. 10 is a side elevation view of the retraction mechanism of FIG. 8.

FIG. 11 is a sectional view of a second example of a male plug connector including a second example of retraction mechanism.

### DETAILED DESCRIPTION

The disclosed male plug connectors will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various male plug connectors are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

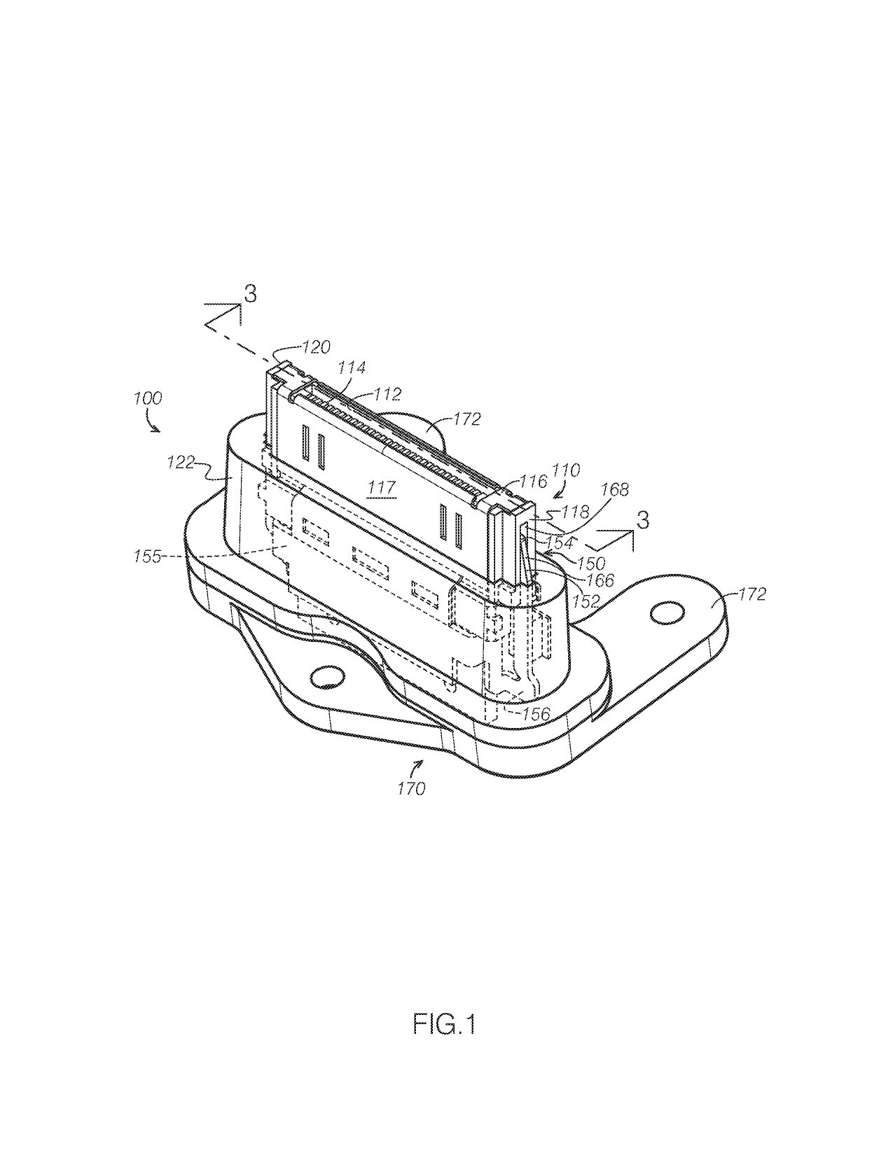

With reference to FIG. 1, a male plug connector 100 includes an insert 110 and a retraction mechanism 150. Male plug connector 100 serves as a terminal end of a cable. Plug connector 100 enables the cable to connect with a device, such as a portable music player, a personal data assistant, a cellular phone, a smart phone, a tablet computer, or a notebook computer, via a complimentarily configured female receptacle.

Plug connector 100 is configured to communicate data and/or power between a first device and a second device (or simply a power source) via the cable. Plug connector 100 may communicate just data, just power, or both. As is well known in the art, a cable, sometimes referred to as a data cable or a power cable, can transfer data and/or power between devices or power sources connected on either end of the cable (not pictured). Suitable cables will generally be insulated and may also be electromagnetically shielded.

As is well known in the art, male plug connectors may be selectively inserted into a female receptacle 130 and selectively removed from the receptacle. However, plug connector 100 is configured to readily disengage from female receptacle 130, as explained in more detail below, to make disengaging plug connector 100 from receptacle 130 more convenient than is possible with conventional male plug connectors.

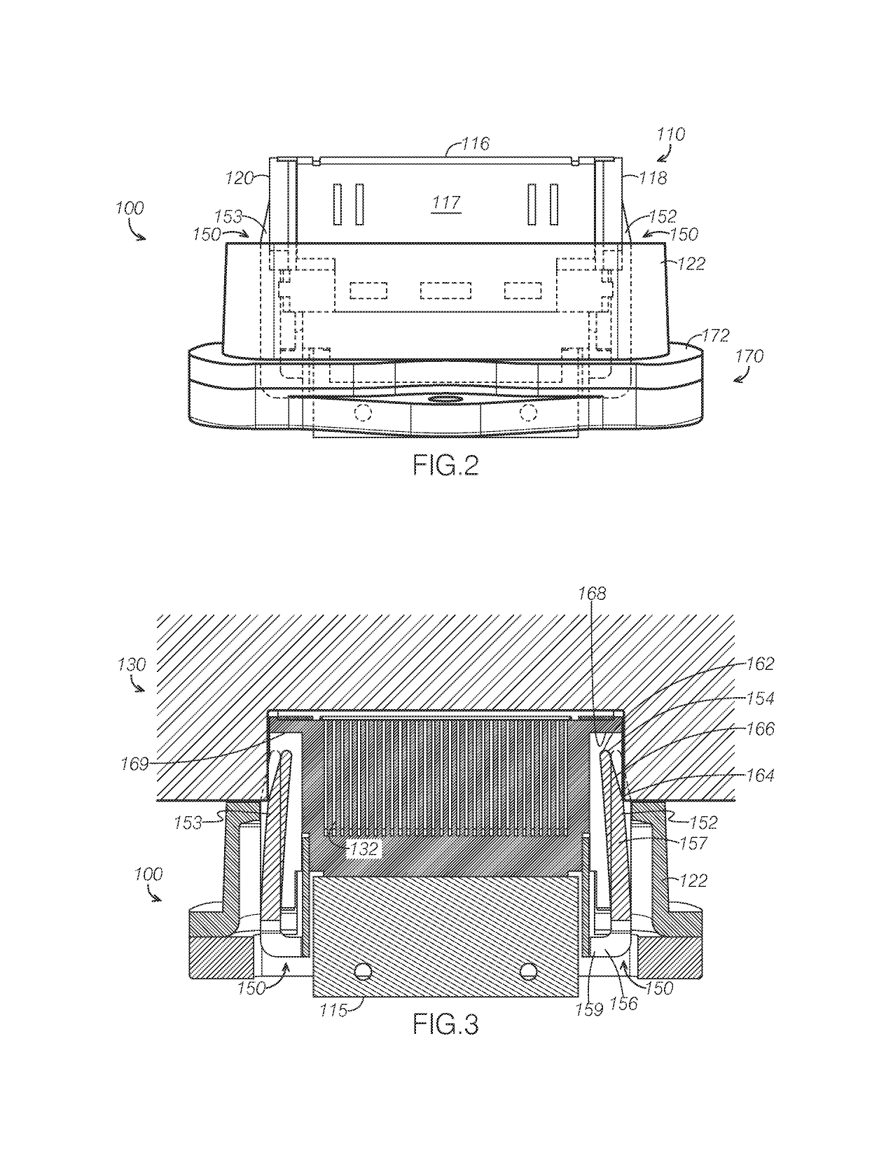

As shown in FIGS. 1-3, insert 110 includes a base 115, a leading edge or tip 116 opposite base 115, and a body 117 extending between base 115 and tip 116. Further, with reference to FIGS. 1 and 2, insert 110 includes a first lateral side 118 and a second lateral side 120 opposite first lateral side 118.

Insert 110 is configured to insert tip 116 and a portion of body 117 into receptacle 130 and to serve as a data and power interface. To facilitate inserting connector 100 into a female receptacle 130, insert 110 is complimentarily configured with female receptacle 130. In particular, insert 110 is slightly narrower in width than the corresponding dimensions of conventional receptacles. The depth of insert 110 is selected to correspond to the depth of known receptacles.

In contrast to inserts included in conventional plug connectors, insert 110 does not include detents proximate its leading edge. Conventional plug connectors include detents designed to engage corresponding retention pits in the female receptacle to secure insert 110 within the female receptacle. The detent and pit arrangement of conventional plug connectors and receptacles has been observed to make disengaging the plug connector from the receptacle difficult and a two-handed operation. The designs discussed herein, in contrast, facilitate a user readily disengaging plug connector 100 from a female receptacle, whether the female receptacle includes retention pits or not.

Insert 110 defines a recess 112 and includes a series of electrical contacts (or pins) 114 mounted inside recess 112. Electrical contacts 114 form channels within recess 112 at a depth selected to line up with female contacts 132 mounted within female receptacle 130. When insert 110 is mounted within female receptacle 130, contacts 114 contact female contacts 132 of female receptacle 130. Indeed, in FIG. 3 female contacts 132 are shown inserted into the channels defined by electrical contacts 114. When contacts 114 are in contact with female contacts 132, data and/or power can be exchanged from plug connector 100 and female receptacle 130, which is typically in data and/or power communication with a device.

Connector 100 includes 30 electrical contacts (or pins) 114, but may include any number of electrical contacts as needed for different applications. For example, the connector may include 1 or 2 contacts, 9 contacts, or may include 40 or 50 contacts, depending on different needs for exchanging data and/or power. In some examples, the connector will include the same number of contacts as there are female contacts in a given female receptacle. However, the connector may have fewer contacts or more contacts than the female receptacle.

The male plug connector may be labeled or referred to by the number of electrical contacts or pins it includes. For example, a connector with 30 electrical contacts may be referred to as a 30-pin connector. In examples where the male plug connector includes 9 electrical contacts, it may be referred to as a 9-pin connector.

The electrical contacts may be spring biased toward the electrical contacts of the female receptacle. Spring biasing the contacts helps maintain the male and female contacts in contact with one another in the event the connector is bumped, shaken, or otherwise moved. However, the spring biased contacts may function as a clamp and thus inhibit a user's efforts to remove the connector from the female receptacle. The extra effort needed to overcome the clamping force of the spring biased contacts, which is sometimes referred to as increased friction, can make removing the connector more difficult and less convenient, as described above in the background section. In some examples, the contacts of the connector are not spring biased to alleviate the extra force needed to remove the connector.

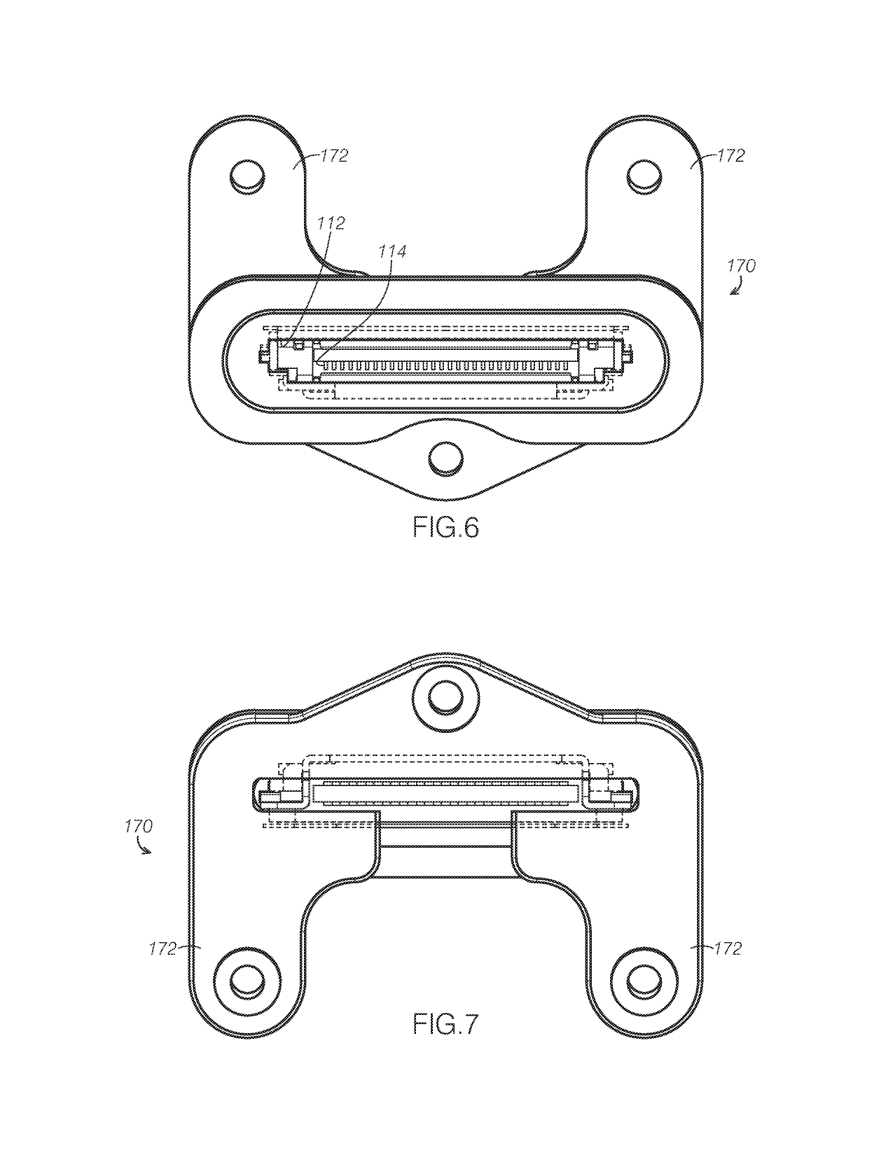

In the example shown in FIGS. 1-7, male plug connector 110 includes a protective housing 122. Protective housing 122 covers internal components, such as portions of body 117 and retraction mechanism 150 as well as the interface between insert 110 and the cable. Protective housing 122 serves as a backstop when insert 110 inserts into female receptacle 130 to restrict insert 110 from inserting too far into female receptacle 130. Protective housing may adopt any suitable shape and may incorporate any currently known or later developed features.

Retraction mechanism 150 is configured to urge insert 110 out of the female receptacle 130 when a user desires to disengage plug connector 100 from the receptacle. The outward bias provided by retraction mechanism 150 can help overcome the problems with removing insert 110 from female receptacle 130 described above, including the clamping force of spring biased contacts, retention detents on the insert aligned with retention pits on the female receptacle, and a tight fitment in general.

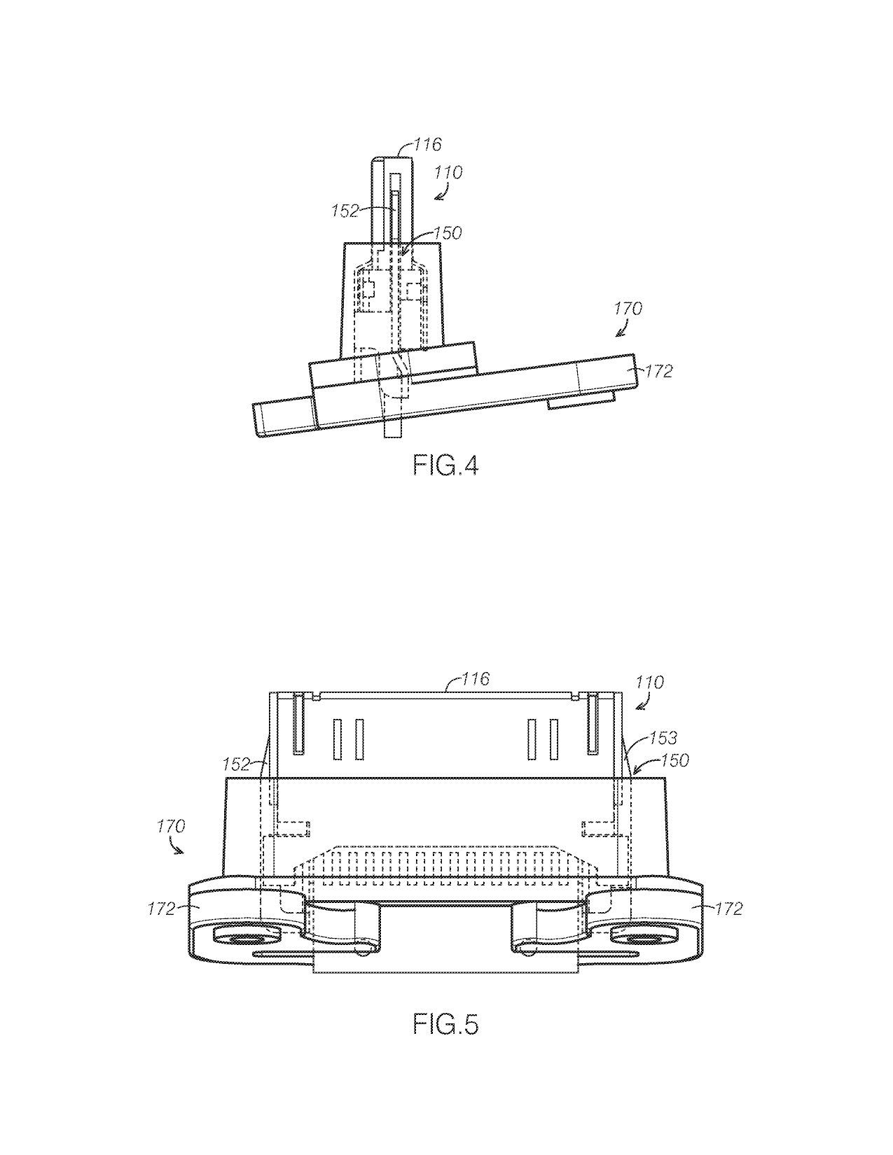

As shown in FIGS. 4 and 5, retraction mechanism 150 includes a first wedge member 152 and a second wedge member 153, both laterally adjacent insert 110. First wedge member 152 is laterally opposite insert 110 from second wedge member 153 and connected to second wedge member 153 via a cross member 155.

In FIG. 3, first and second wedge members 152 and 153 are shown in dotted lines in a rest position where the wedge members are in a position to be pressed toward insert 110 into a loaded position, shown in solid lines, by receptacle 130 when insert 110 is inserted into receptacle 130. As shown in FIGS. 1 and 3, insert 110 defines wedge member recesses 168 and 169 to receive the wedge members 152 and 153, respectively, when the wedge member 152 is pressed into the loaded position by the receptacle 130.

First and second wedge members 152 and 153 are resilient and biased to be positioned in the rest position. Wedge members 152 and 153 define a leaf spring, which may also be referred to as a tangential spring or detent.

The bias of wedge members 152 and 153 towards their respective rest positions causes wedge members 152 and 153 to press against receptacle 130 and urge insert 110 out of female receptacle 130. Indeed, with reference to the FIG. 3, as connector 100 is inserted into female receptacle 130, wedge members 152 and 153 contact the lateral sides of female receptacle 130 and resiliently bend toward insert 110 into the loaded position. In the loaded position, wedge members 152 and 153 urge insert 110 out of female receptacle 130 due to their resiliency and their wedge shaped heads, which are explained in more detail below.

However, the resiliency of wedge members 152 and 153 is selected to allow insert 110 to remain within female receptacle 130 until a user starts to separate connector 100 from female receptacle 130. Thus, retraction mechanism 150 is calibrated to facilitate disengaging connector 100 from female receptacle 130 once a user begins to disengage connector 100, but to not cause connector 100 to disengage from female receptacle 130 on account of the wedge members' urging alone.

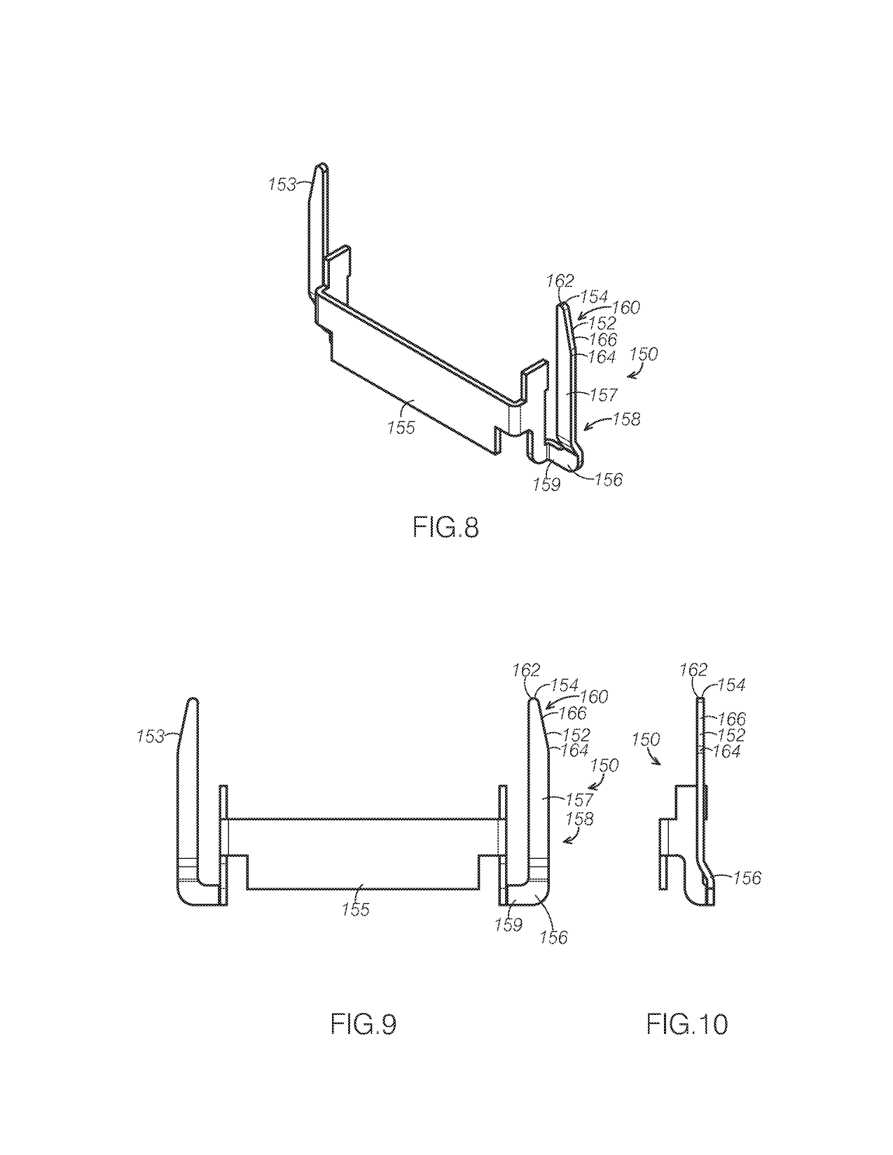

Expressed another way, the bias of wedge member 152 in the loaded position may be selected to exert a withdrawing force on insert 110 that exceeds the force of kinetic friction between insert 110 and receptacle 130 resisting insert 110 from withdrawing from receptacle 130. In the examples shown in FIGS. 1-10, the bias is further selected to not exceed the force of static friction between insert 110 and receptacle 130. Indeed, retraction mechanism 150 ejects insert 110 from receptacle 130 once a user overcomes the force of static friction holding insert 110 within receptacle 130.

In some examples, the resiliency of the wedge members is selected to exert a withdrawing force exceeding the forces tending to retain the insert in the female receptacle, such as the force of static friction existing between the components. In such examples, the withdrawing force exerted by the retraction mechanism ejects the insert from the female receptacle unless the insert is retained in the female receptacle by a retention member. Thus, the male plug connector may include a retention member or may cooperate with a retention member disposed on the device or the female receptacle. The retention mechanism may be selectively disengaged to allow the retraction mechanism to eject the insert.

In some examples, the retraction mechanism includes distinct springs that bias the wedge members away from the insert as opposed to or supplementing the resilient wedge members. In the example described in this paragraph, the wedge members compress the springs when they contact the lateral sides of the female receptacle as the plug connector is inserted into the female receptacle. The outward bias supplied by the springs cause the wedge member to urge the insert out of the female receptacle similar to as described above.

With reference to FIGS. 1-10, the reader can see that wedge members 152 and 153 are substantially identical, mirror images of one another in the example shown in the figures. As a result, for the sake of brevity, this description will in general describe first wedge member 152 in detail and the reader should understand that the same details apply to second wedge member 153.

However, in some examples the first and second wedge members have different features and are not identical. In still further examples, the retraction mechanism includes a single wedge member. Other suitable retraction mechanism examples include more than two wedge members.

As can be seen in FIGS. 1-10, wedge member 152 is elongate and extends from a first end 154 proximate leading edge 116 and a second end 156 opposite first end 154. In the example shown in the figures, second end 156 is fixedly secured to cross member 155, which is secured to insert 110. Second end 156 forms a cantilever 158 from cross member 155 where first end 154 resiliently moves between the rest position and the loaded position when insert 110 is inserted into receptacle 130.

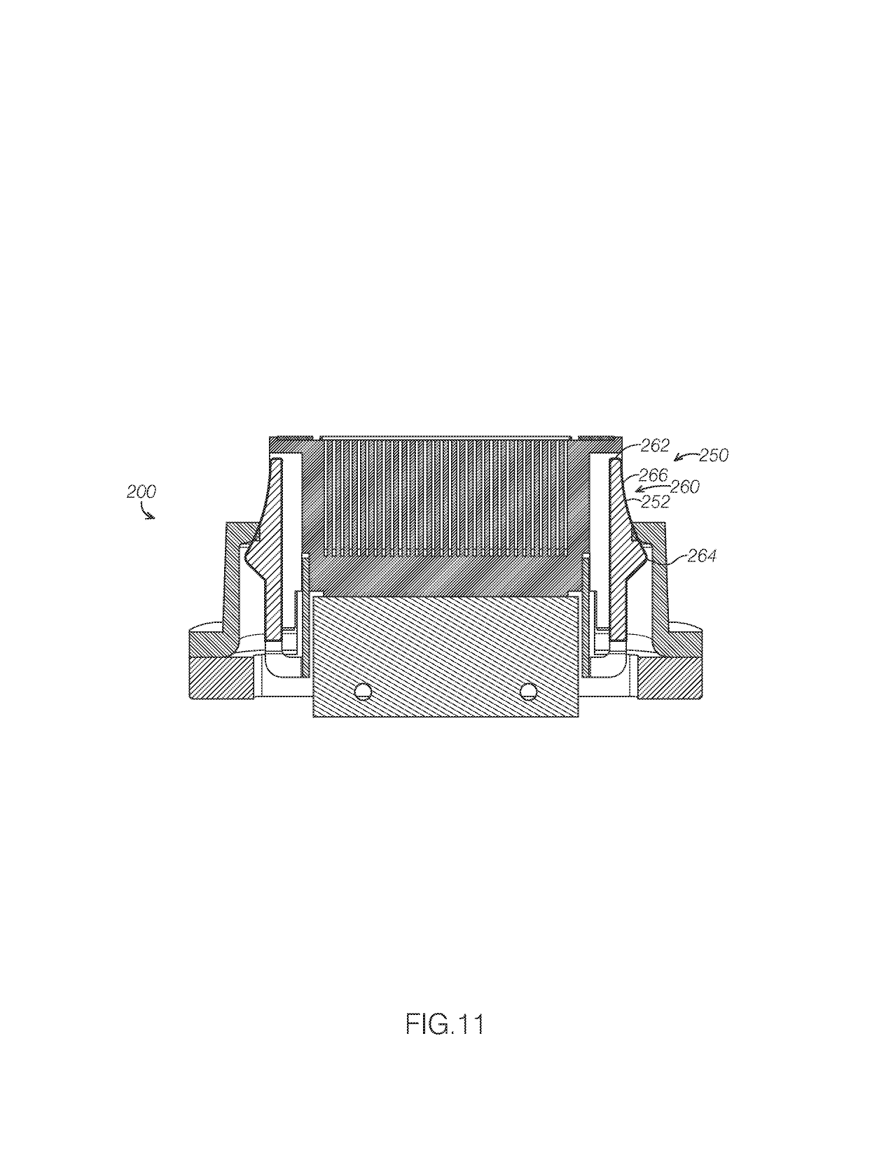

First wedge member 152 includes a head 160 proximate leading edge 116 and distal base 115, a neck 157 extending from head 160 toward base 115, and a shoulder 159 extending transverse to neck 157 to secure to cross member 155. In the example shown in FIGS. 1-10, head 160 is wedge shaped. However, head 160 may adopt other shapes, such as a curved profile as shown in FIG. 11, which depicts a head 260.

As shown in FIGS. 3 and 8-10, head 160 extends from a head first end 162 proximate leading edge 116 of insert 110 and a head second end 164 opposite head first end 162. Head 160 includes an outer edge 166 distal insert 110. The wedge configuration of head 160 is defined by outer edge 166 at head second end 156 projecting from insert 110 a greater distance than outer edge 166 projects from insert 110 at head first end 162. In the configuration shown in FIGS. 1-10, outer edge 166 of head 160 is slanted in a substantially straight line between head first end 162 and head second end 164. In other examples, such as shown in FIG. 11, an outer edge 266 of head 260 is curved between a head first end 262 and a head second end 264.

With further reference to FIG. 11, a second example of a retraction member wedge member is shown, wedge member 252. As can be seen in FIG. 11, a retraction mechanism 250 includes wedge member 252 with a head 260. Head 260 is curved as compared to straight like head 160 of wedge member 152. The curved shape of head 260 shown in FIG. 11 has been observed to increase the retracting bias force of retraction mechanism 250 as the insert is inserted deeper into the female receptacle. The escalating retracting bias force provided by wedge member 252 including head 260 with a curved outer profile may enhance the user experience as less force is required to initially insert the insert than is required to fully insert it into the female receptacle. Likewise, the retracting bias force is greater the deeper the insert is inserted into the female receptacle.

Returning attention to FIG. 1, the reader can see that connector 100 includes a platform 170 serving as a base supporting insert 110. However, platform 170 is an optional feature not present in all examples. Platform 170 includes feet 172 and supports insert 110 in a generally vertical or upright orientation.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A male plug connector, comprising:
an insert configured to insert into a complimentarily configured receptacle, the insert defining a recess and including one or more insert electrical contacts mounted within the recess in a position to contact one or more corresponding receptacle electrical contacts mounted within the receptacle when the insert is inserted into the receptacle; and
a retraction mechanism operatively connected to the insert and configured to urge the insert out of the receptacle when a user desires to withdraw the insert from the receptacle.

2. The male plug connector of claim 1, wherein the retraction mechanism includes a wedge member adjacent the insert in a rest position where the wedge member is in a position to be pressed toward the insert into a loaded position by the receptacle when the insert is inserted into the receptacle.

3. The male plug connector of claim 2, wherein the wedge member in the loaded position is biased toward the rest position and presses against the receptacle.

4. The male plug connector of claim 1, wherein the wedge member is resilient.

5. The male plug connector of claim 4, wherein the wedge member is elongate and extends from a first end proximate a leading edge of the insert and a second end opposite the first end, the second end being fixedly secured to the insert to form a cantilever where the first end resiliently moves between the rest position and the loaded position when the insert is inserted into the receptacle.

6. The male plug connector of claim 5, wherein the wedge member includes a head that extends from a head first end proximate the leading edge of the insert and a head second end opposite the head first end, the head including an outer edge distal the insert, the outer edge at the head second end projecting from the insert a greater distance than the outer edge projects from the insert at the head first end.

7. The male plug connector of claim 6, wherein the outer edge of the head is slanted in a straight line between the head first end and the head second end.

8. The male plug connector of claim 6, wherein the outer edge of the head is curved between the head first end and the head second end.

9. The male plug connector of claim 3, wherein the wedge member includes a head that extends from a head first end proximate a leading edge of the insert and a head second end opposite the head first end, the head including an outer edge distal the insert, the outer edge at the head second end projecting from the insert a greater distance than the outer edge projects from the insert at the head first end.

10. The male plug connector of claim 9, wherein the outer edge of the head is slanted in a straight line between the head first end and the head second end.

11. The male plug connector of claim 9, wherein the outer edge of the head is curved between the head first end and the head second end.

12. The male plug connector of claim 2, wherein the insert defines a wedge member recess to receive the wedge member when the wedge member is pressed into the loaded position by the receptacle.

13. The male plug connector of claim 3, wherein the bias of the wedge member in the loaded position is selected to exert a withdrawing force on the insert that exceeds the force of static friction between the insert and the receptacle resisting the insert from withdrawing from the receptacle such that the retraction mechanism ejects the insert from the receptacle unless the insert is selectively secured in a position within the receptacle.

14. The male plug connector of claim 3, wherein the bias of the wedge member in the loaded position is selected to exert a withdrawing force on the insert that exceeds the force of kinetic friction between the insert and the receptacle resisting the insert from withdrawing from the receptacle, but does not exceed the force of static friction between the insert and the receptacle such that the retraction mechanism ejects the insert from the receptacle once a user overcome the force of static friction holding the insert within the receptacle.

15. A male plug connector, comprising:
an insert configured to insert into a complimentarily configured receptacle, the insert including:
one or more insert electrical contacts mounted in a position to contact one or more corresponding receptacle electrical contacts when the insert is inserted into the receptacle,
a leading edge that leads the insert into the receptacle,
a first lateral side, and
a second lateral side opposite the first lateral side; and
a retraction mechanism operatively connected to the insert and configured to urge the insert out of the receptacle when a user desires to withdraw the insert from the receptacle, the retraction mechanism including:
a first wedge member adjacent the insert on the first lateral side of the insert, and
a second wedge member adjacent the insert on the second lateral side of the insert;
wherein the first wedge member and the second wedge member are each configured to move between a rest position distal the insert and a loaded position proximate the insert.

16. The male plug connector of claim 15, wherein the first and second wedge member are configured to move from the rest position to the loaded position when the insert inserts into the receptacle by the receptacle pressing the first and second wedge members toward the insert.

17. The male plug connector of claim 15, wherein the first and second wedge members are resilient and biased to move from the loaded position to the rest position.

18. The male plug connector of claim 15, wherein the first and second wedge members each include a head that extends from a head first end proximate the leading edge of the insert and a head second end opposite the head first end, the head including an outer edge distal the insert, the outer edge at the head second end projecting from the insert a greater distance than the outer edge projects from the insert at the head first end.

19. The male plug connector of claim 18, wherein the outer edge of the head is slanted in a straight line between the head first end and the head second end.

20. The male plug connector of claim 18, wherein the outer edge of the head is curved between the head first end and the head second end.
